(19) United States
(12) Patent Application Publication
(10) Pub. No.: US 2021/0397139 A1
(43) Pub. Date: Dec. 23, 2021

(54) METHODS FOR SHARING A WATCH FACE ON AN ELECTRONIC DEVICE

(71) Applicant: Apple Inc., Cupertino, CA (US)

(72) Inventors: Anthony D'AURIA, San Francisco, CA (US); Giovanni M. AGNOLI, San Mateo, CA (US); Matthew J. SUNDSTROM, Campbell, CA (US); Jared Keith MCGANN, San Jose, CA (US)

(21) Appl. No.: 17/350,865

(22) Filed: Jun. 17, 2021

Related U.S. Application Data
(60) Provisional application No. 63/041,883, filed on Jun. 20, 2020.

(51) Int. Cl. G04G 9/00; G04G 17/04; G04G 21/00; G06F 3/0487; G06F 3/14

(52) U.S. Cl. CPC G04G 9/0064; G04G 17/045; G06F 3/1454; G06F 3/0487; G04G 21/00

(57) ABSTRACT

In some examples, an electronic device receives a watch face package. In some examples, the watch face package includes one or more definitions of visual characteristics of one or more portions of a respective watch face. In some examples, a respective definition corresponding to a respective portion of the watch face includes first display data associated with the respective portion of the watch face and second display data associated with the respective portion of the watch face. In some examples, after receiving the watch face package, in accordance with a determination that one or more criteria are satisfied, the electronic device generates the second appearance of the visual characteristic of the respective portion of the respective watch face using the second display data associated with the respective portion of the watch face.

### CROSS-REFERENCE TO RELATED APPLICATIONS

This application claims the benefit of U.S. Provisional Application No. 63/041,883, filed Jun. 20, 2020, the contents of which is incorporated herein by reference in its entirety for all purposes.

### FIELD OF THE DISCLOSURE

This relates generally to sharing watch faces on an electronic device.

### BACKGROUND OF THE DISCLOSURE

An electronic watch device can include a display that can be configured to display one or more watch faces (e.g., watch face profiles). The watch faces for the electronic watch device can be managed and/or configured on the electronic watch device itself or on another electronic device that is in communication with the electronic watch device. Accordingly, it may be desired to share the settings for one or more of the watch faces with another electronic device.

### SUMMARY OF THE DISCLOSURE

Sharing watch face settings can advantageously be used to add new watch faces to another electronic device. In some examples, the receiving electronic device is able to install the received watch face and configure an electronic watch device to display the received watch face. In some examples, upon receiving a watch face package that includes the settings for a respective watch face, an electronic device can display a preview of the respective watch face using data in the watch face package. In some examples, when displaying the preview of the respective watch face, the electronic device can use a pre-generated image for certain portions of the watch face or use the settings contained in the watch face package to generate images for other portions of the watch face. In some examples, the electronic device can prompt the user to install one or more applications that are associated with portions of the respective watch face. In some examples, in response to a request to share a watch face with another electronic device, the electronic device can prompt the user whether to include certain portions of the watch face in the watch face package and/or whether to include certain data associated with the respective portions of the watch face in the watch face package.

### BRIEF DESCRIPTION OF THE DRAWINGS

FIG. 1 illustrates a block diagram of an example multifunction device capable of performing the methods disclosed herein according to some examples of the disclosure.

FIGS. 2A-2E illustrate example electronic devices capable of performing the methods disclosed herein according to some examples of the disclosure.

FIGS. 3A-3B illustrates example watch faces according to some examples of the disclosure.

FIG. 4 illustrates an exemplary watch face package according to some examples of the disclosure.

FIG. 5 illustrates exemplary settings for an exemplary watch face according to some examples of the disclosure.

FIG. 6 illustrates an exemplary display of a preview of a watch face according to some examples of the disclosure.

FIG. 7 illustrates an exemplary display of a preview of a watch face according to some examples of the disclosure.

FIG. 8 illustrates an exemplary method of displaying a preview of a watch face according to some examples of the disclosure.

FIG. 9 illustrates an exemplary method of generating a watch face package according to some examples of the disclosure.

FIG. 10 illustrates an exemplary method of generating a watch face package according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Sharing watch face settings can advantageously be used to add new watch faces to another electronic device. In some examples, the receiving electronic device is able to install the received watch face and configure an electronic watch device to display the received watch face. In some examples, upon receiving a watch face package that includes the settings for a respective watch face, an electronic device can display a preview of the respective watch face using data in the watch face package. In some examples, when displaying the preview of the respective watch face, the electronic device can use a pre-generated image for certain portions of the watch face or use the settings contained in the watch face package to generate images for other portions of the watch face. In some examples, the electronic device can prompt the user to install one or more applications that are associated with portions of the respective watch face. In some examples, in response to a request to share a watch face with another electronic device, the electronic device can prompt the user whether to include certain portions of the watch face in the watch face package and/or whether to include certain data associated with the respective portions of the watch face in the watch face package.

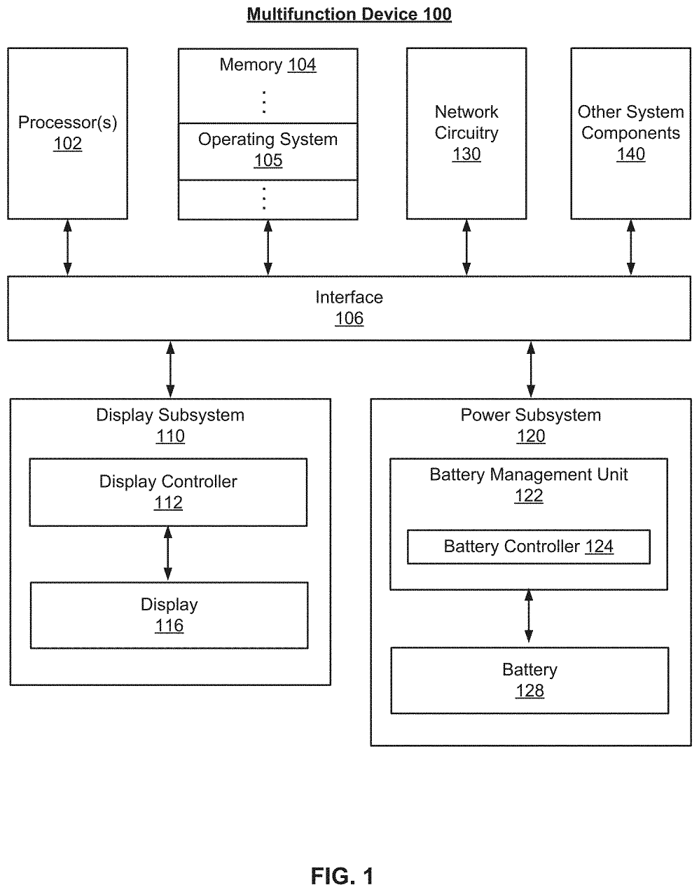

FIG. 1 illustrates a block diagram of an example multifunction device 100 capable of performing the methods disclosed herein according to some examples of the disclosure. In some examples, device 100 includes one or more processors 102 and memory 104, a display subsystem 110 and power subsystem 120, and network circuitry 130. Device 100 can also include other components 140 not otherwise illustrated in FIG. 1. In some examples, these components communicate over one or more communication buses or signal lines (e.g., interface 106). It should be appreciated that device 100 is only one example of a multifunction device, and that device 100 optionally has more or fewer components than shown, optionally combines two or more components, or optionally has a different configuration or arrangement of the components. The various components shown in FIG. 1 are implemented in hardware, software, or a combination of both hardware and software, including one or more signal processing and/or application-specific integrated circuits (ASICs).

In some examples, memory 104 (e.g., a non-transitory computer readable storage medium) optionally includes high-speed random access memory and optionally also includes non-volatile memory, such as one or more magnetic disk storage devices, flash memory devices, or other non-volatile solid-state memory devices. The one or more processors 102 can run or execute various software programs and/or sets of instructions stored in memory 104 to perform various functions for device 100 and to process data. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some examples, memory 104 stores instructions for executing the operating system 105 of device 100. In some examples, memory 104 includes a single memory component or a combination of multiple memory components. Operating system 105 can include various procedures, sets of instructions, software components and/or drivers for controlling and managing general system tasks (e.g., memory management, storage device control, power management, etc.) and facilitates communication between various hardware and software components.

In some examples, memory module(s) in memory 104 can correspond to a set of instructions for performing one or more functions described above and the methods described in this application (e.g., the computer-implemented methods and other information processing methods described herein). In some embodiments, the memory, when executed one or more processors, can cause the processors 102 (e.g., and/or the device) to perform the methods described below. These modules (i.e., sets of instructions) need not be implemented as separate software programs, procedures or modules, and thus various subsets of these modules may be combined or otherwise rearranged in various examples. In some examples, memory 104 may store a subset of the modules and data structures identified above. Furthermore, memory 104 may store additional modules and data structures not described above.

Network circuitry 130 sends and receives communication signals, such as wired or wireless signals. Network circuitry 130 optionally includes well-known circuitry for performing these functions, including but not limited to an antenna system, a transceiver, one or more amplifiers, a tuner, one or more oscillators, a digital signal processor, a CODEC chipset, a subscriber identity module (SIM) card, memory, and so forth. Network circuitry 130 optionally communicates with networks, such as the Internet, also referred to as the World Wide Web (WWW), an intranet and/or a wireless network, such as a cellular telephone network, a wired local area network (LAN), a wireless local area network (WLAN) and/or a metropolitan area network (MAN), and other devices by wired or wireless communication. Network circuitry 130 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Device 100 can include one or more input controllers (not shown) for receiving/sending electrical signals from/to input control devices. The input control devices optionally include physical buttons (e.g., push buttons, rocker buttons, etc.), dials, slider switches, joysticks, click wheels, and so forth. In some alternate examples, input controller(s) are, optionally, coupled to any (or none) of the following: a keyboard, an infrared port, a USB port, and a pointer device such as a mouse. The one or more buttons optionally include an up/down button for volume control. The one or more buttons optionally include a push button.

Display subsystem 110 manages and/or controls the interaction of device 100 with display 116. In some examples, display subsystem 110 includes a display controller 112 (e.g., displayer controller circuitry) and display 116. In some examples, display 116 is a touch-sensitive display. Display 116 provides an output interface and optionally an input interface between the device and a user. Display controller 112 receives and/or sends electrical signals from/to display 116. Display 116 displays visual output to the user. The visual output optionally includes graphics, text, icons, video, and any combination thereof (collectively termed “graphics”). In some examples, some or all of the visual output optionally corresponds to user-interface objects.

In some examples, in addition to the display, device 100 optionally includes a touchpad (not shown) for activating or deactivating particular functions. In some examples, the touchpad is a touch-sensitive area of the device that, unlike the touch screen, does not display visual output. The touchpad is, optionally, a touch-sensitive surface that is separate from display 112 or an extension of the touch-sensitive surface formed by the display.

Device 100 also includes power system 120 for powering the various components of device 100. Power subsystem 120 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and/or distribution of power in devices. In the example illustrated in FIG. 1, device power subsystem 120 includes a battery management system 122 for controlling and/or managing interactions with battery 128. In some examples, battery management system 122 is a discrete hardware component (e.g., circuitry) and includes a battery controller 124 that receives and/or sends electrical signals from/to battery 128. Battery 128 stores and provides power to the various components of device 100. Battery 128 can also be recharged from an external power source. In some examples, battery 128 can be composed of one or more battery cells (e.g., lithium ion or other chemical components) that store electrical charge.

In some examples, device 100 includes one or more other components 140 that are not otherwise described above. Examples of such components include displays, batteries, buttons, memory, antennas, sensors, keyboards, dials, touchpads, speakers, etc.

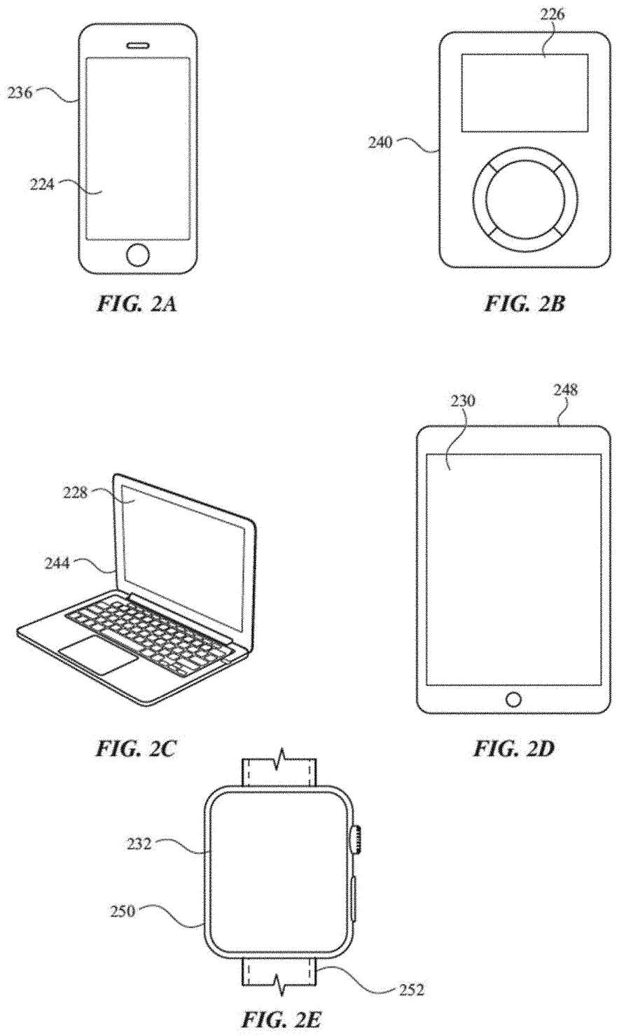

FIGS. 2A-2E illustrate example electronic devices capable of performing the methods disclosed herein according to some examples of the disclosure. The devices illustrated in FIG. 2A-2E can share features of multifunctional device 100 described above with respect to FIG. 1 and can include, inter alia, any or all of the components described with respect to device 100. FIG. 2A illustrates an example mobile telephone 236 that includes a touch screen 224 (e.g., the iPhone® from Apple Inc. of Cupertino, Calif.) that can perform the methods according to examples of the disclosure. FIG. 1B illustrates an example digital media player 240 (e.g., iPod Touch® from Apple Inc.) that includes a touch screen 226 that can perform the methods according to examples of the disclosure. FIG. 2C illustrates an example personal computer 244 (e.g., iMac®, MacBook® from Apple Inc.) that includes a touch screen 228 that can perform the methods according to examples of the disclosure. FIG. 2D illustrates an example tablet computing device 248 (e.g., iPad® from Apple Inc.) that includes a touch screen 230 that can perform the methods according to examples of the disclosure. FIG. 2E illustrates an example wearable device 250 (e.g., Apple Watch® from Apple Inc.) that includes a touch screen 232, that can be attached to a user using a strap 252, and that can perform the methods according to examples of the disclosure. Additionally, it should be understood that although the electronic devices of FIGS. 2A-2E include touch screens, the methods described herein can be performed without a touch screen or a display. Additionally, the electronic devices may include one or more other physical user-interface devices, such as a physical keyboard, a mouse, and/or a joystick.

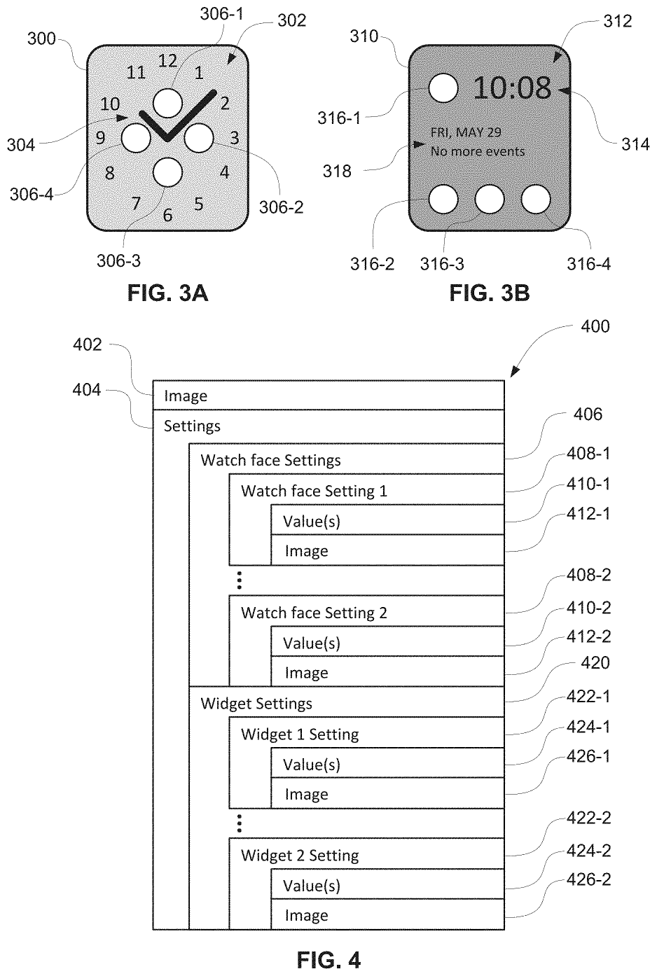

Attention is now directed to FIGS. 3-10, which illustrate example methods of sharing and/or displaying watch faces on an electronic device. In some examples, an electronic watch (e.g., such as wearable device 250) displays, via a display (e.g., such as touch screen 232), a watch face. In some embodiments, a watch face is a default user interface displayed by an electronic watch device, optionally including a time indicator. In some embodiments, the watch face is a user interface that includes one or more elements. Examples of these elements include elements that indicate the current time of day, such as watch dials, time markers, watch hands, time indicators, etc. In some embodiments, the user interface includes elements that provide information other than the current time of day. For example, the user interface can include one or more widgets associated with one or more applications that are installed on the electronic device. In some embodiments, the one or more applications can be system applications (e.g., native applications) or third-party applications. In some embodiments, the user interface can include one or more aesthetic elements, such as a background image, background animation, etc. As referred to herein, a watch face is a set of visual characteristics that, in combination, define the look and behavior of a respective user interface of a watch. In some embodiments, a user is able to select from different watch faces for display on the electronic watch. In some embodiments, each watch face can include a different set of settings that define the visual characteristic of different portions of the watch face. The methods and systems illustrated below discuss ways in which a watch face package can be generated based on a watch face, transmitted to another device, and/or added to an electronic watch. It is understood that the processes described below can be used for any user interface for any type of device (e.g., home screen user interface, desktop user interface, etc. for a mobile device, a computing device, etc.).

It is understood that although FIGS. 3-7 depict an electronic device 500, the processes described below can be performed on any of the above-discussed devices (e.g., such as multifunction device 100, mobile telephone 236, digital media player 240, personal computer 244, tablet computing device 248, wearable device 250, etc.). In some embodiments, electronic device 500 is a multifunctional device separate from an electronic watch device and electronic device 500 is in communication with the electronic watch device and is configured to manage the electronic watch device. For example, electronic device 500 is able to receive, modify, and/or change one or more settings on an electronic watch device including adding and/or modifying the watch face settings of the electronic watch device.

FIGS. 3A-3B illustrate exemplary watch faces 300 and 310 according to some examples of the disclosure. As described above, an electronic watch, such as wearable device 250, can display any suitable watch face, such as watch face 300 and watch face 310. As shown in FIG. 3A, watch face 300 includes one or more watch face elements that define the look and/or behavior of respective portions of the watch face. In FIG. 3A, watch face 300 includes background 302 and an analog clock (e.g., hands 304 and hours markers). In some embodiments, watch face 300 includes widget 306-1, widget 306-2, widget 306-3, and widget 306-4. As used herein, a widget is a watch face element that displays information from one or more applications installed on the device or system processes of the device. In some embodiments, the look and behavior of a widget is managed and/or configured by its respective application. For example, a widget can be a temperature widget that displays the current temperature based on information received from a weather application, an activity widget that displays the number of steps the user has taken based on information received from an activity application, a battery widget that displays the current battery level based on information received from a battery management process, etc. In some embodiments, a widget is interactable (e.g., selectable) by a user to cause display of the respective application associated with the widget (e.g., temperature widget is selectable to display the weather app, etc.).

In some embodiments, any of the elements of watch face 300 can be customized or configured. For example, background 302 can be any of a color, image, video, slideshow, animation, etc. and a user is able to select the type of background (e.g., a color, an image, a video, etc.), and the content of the background (e.g., the color, the image, the video, etc.). In some embodiments, the user is able to define the shape, size, and/or color of hands 304. In some embodiments, the user is able to define the style of the watch dial (e.g., the font type of the hours markers, the size of the hours markers, and/or the color of the hours markers, etc.). In some embodiments, a user is able to select the widget to be displayed at predefined locations on the watch face. For example, in FIG. 3A, widgets 306-1 to 306-4 are located above, to the right, below, and to the left of the center of watch face 300. In some embodiments, the available locations for widgets are pre-defined (e.g., based on the type of watch face) and any or all of the predefined locations can be populated with a widget (or left unpopulated).

In FIG. 3B, watch face 310 has a different theme and/or template than watch face 300. For example, instead of an analog time indicator (e.g., indicating the time using a hours hand and/or a minutes hand), watch face 310 includes a digital time indicator 314 (e.g., indicating the time using numeric digits, such as 12:50, 1:30, etc.). Thus, in some embodiments, watch faces can be based on pre-determined watch faces templates and the settings, options, and/or customizations (e.g., the settings included in a watch face package, such as watch face package 400 described below) can be define the modifications to be performed to the respective watch face template to achieve a customized watch face. As shown in FIG. 3B, watch face 310 includes background 312, which can be configured to display a particular color, image, graphic, etc. As shown in FIG. 3B, background 312 is different than background 302 (e.g., a different color, a different type of graphic, etc.). In some embodiments, watch face 310 includes widget 316-1, widget 316-2, widget 316-2, and widget 316-4.

As shown in FIG. 3B, widgets 316-1 to 316-4 are located at different locations than the widgets in watch face 300. For example, widget 316-1 is displayed at the top-left of watch face 310, to the left of digital time indicator 314, and widgets 316-2 to 316-4 are displayed in a row at the bottom of watch face 310. In some embodiments, the set of predefined locations for widgets for watch face 310 is different than the set of predefined locations for widgets for watch face 300. In FIG. 3B, watch face 310 includes calendar widget 318. In some embodiments, calendar widget 318 displays the current date and any events that are scheduled for the current date (e.g., in FIG. 3B, the current date is Friday, May 29, and there are no events scheduled for the current date).

As shown in FIG. 3B, different widgets can have different shapes and/or sizes. In some embodiments, the shape and/or size of a widget can depend on the location of the widget. For example, respective predefined locations for widgets can support larger widgets while other locations only support smaller widgets. In some embodiments, a widget can be displayed in a smaller mode or larger mode based on whether the location supports larger or smaller widgets (optionally the widget displays more or different information when in the larger mode as compared to the smaller mode). It is understood that any number of modes, shapes, and/or sizes are possible.

Thus, as shown above, different watch faces can have different visual characteristics and behaviors. It is understood that watch faces other than those illustrated in FIGS. 3A and 3B are possible. In some embodiments, the look and feel of a watch face can be defined by a set of settings. In some embodiments, the set of settings can indicate the base type of watch face, the user's customizations and/or settings for different elements of the watch face, and/or the user's customizations and/or settings for the widgets on the watch face.

The following disclosure describe ways in which an electronic device can package a custom watch face into a watch face package and transmit the watch face package to another electronic device such that another electronic device is able to use the customized watch face without requiring the user to manually create a custom watch face including selecting the appropriate settings for the different visual elements of the watch face. As described above, a watch face can include one or more widgets that are associated with one or more applications installed on the electronic device. Thus, the widgets of a watch face optionally require special treatment to maintain the functionality of the widgets with respect to their corresponding applications. In addition, a watch face optionally displays or includes personally identifiable information or private information of a user. Thus, certain settings of a watch face package need special treatment to protect the privacy of the owner of a watch face. The following disclosure provide methods of addressing these considerations.

FIG. 4 illustrates an exemplary watch face package 400 according to some examples of the disclosure. In some embodiments, a watch face package includes a set of settings that define the visual characteristics and/or behaviors of a respective watch face (e.g., such as watch face 300 and watch face 310). Certain settings in the watch face package can be accompanied by one or more pre-generated images that displays a preview of the respective portion of the watch face when the respective settings are applied, as will be described in further detail below. It understood that watch face package 400 shown in FIG. 4 is merely exemplary and a watch face package 400 is not limited to the organizational structure shown in FIG. 4. For example, a watch face package can have more or fewer entries than those shown in FIG. 4 and a watch face package can have settings other than those shown in FIG. 4.

In FIG. 4, watch face package 400 includes image 402 and settings 404. In some embodiments, image 402 is a pre-generated image of the overall look of the watch face. In some embodiments, image 402 is pre-generated by the device that generated watch face package 400 (e.g., the device on which the respective watch face is installed). For example, image 402 is a preview of the entire watch face, optionally including a preview of the elements on the watch face as defined by the settings of the watch face (e.g., all of the visual elements). In some embodiments, image 402 includes a preview of the look of all of the visual elements of the watch face, such as the widgets, the watch hands, the fonts, the colors, the time indicators, the background, etc. In some embodiments, image 402 includes a preview of the portions of the watch face that do not otherwise have its own pre-generated image in watch face package 400. For example, if watch face package 400 includes a pre-generated image of widget 1 and widget 2, image 402 can include a preview of all portions of the watch face except for the locations associated with widget 1 and widget 2 are empty (e.g., to be filled in by the image of widget 1 and widget 2, as will be described in further detail below). In some embodiments, the pre-generated images are static images (e.g., still images) representing the respective portion of the watch face. In some embodiments, as will be described in further detail below, image 402 is used when displaying a preview of watch face package 400 (e.g., to display a preview of how the respective watch face will look when installed on an electronic watch device). In some embodiments, settings 404 includes one or more global settings associated with the watch face. For example, settings 404 can define the base template of the watch face, the version of the base template, the minimum operating system required to use the watch face, etc. For example, setting 404 for watch face 300 can indicate that watch face 300 is based on a first watch face template in which the time indicator is an analog time indicator, and setting 404 for watch face 310 can indicate that watch face 310 is based on a second watch face template in which the time indicator is a digital time indicator.

In some embodiments, watch face package 400 can include a set of watch face settings 406. Watch face settings 406 can include one or more sets of settings for different watch face elements. For example, watch face setting 1 408-1 can define the type of background (e.g., such as background 302 and background 312) and the content of the background, and watch face setting 2 408-2 can define the font style of the time indicator (e.g., digital time indicator 314). As shown in FIG. 4, watch face setting 1 408-1 can include the settings value(s) 410-1 and a pre-generated image 412-1. In some embodiments, settings value(s) 410-1 include the customizations and options associated with watch face setting 1 408-1. For example, settings value(s) 410-1 can include the type of background, the color of the background, the image of the background, etc. In some embodiments, pre-generated image 412-1 includes a preview of the respective portions of the watch face defined by watch face setting 1 408-1. For example, if watch face setting 1 408-1 defines the settings for the background of the watch face, then image 412-1 can be a pre-generated image of the background (e.g., that includes the user-selected color, the user-selected photo, etc.).

In some embodiments, watch face settings 406 includes watch face setting 2 408-2 corresponding to a second watch face setting that defines the settings for a second watch face element. For example, as described above, watch face setting 2 408-2 can define the font style of the time indicator (e.g., digital time indicator 314). As shown in FIG. 4, watch face setting 2 408-2 can include the settings value(s) 410-2 and a pre-generated image 412-2. In some embodiments, settings value(s) 410-2 include the customizations and options associated with watch face setting 2 408-2. For example, settings value(s) 410-2 can include the font type of the time indicator (e.g., time indicator 314), the font color of the time indicator, etc. In some embodiments, pre-generated image 412-2 includes a preview of the time indicator when values 410-2 are applied. For example, if watch face setting 2 408-2 defines the settings for the time indicator of the watch face, then image 412-2 can be a pre-generated image of the time indicator (e.g., that includes the user-selected font type, the user-selected color, etc.).

In some embodiments, watch face package 400 can include a set of widget settings 420. In some embodiments, widget settings 420 define the settings of the widgets that are displayed on/included in a watch face (e.g., as opposed to watch face settings 406 that are not necessarily associated with widgets and/or applications). In some embodiments, each widget setting (e.g., widget 1 setting 422-1 and widget 2 setting 422-2) is associated with a pre-defined location on the watch face for widgets. For example, widget 1 setting 422-1 can be associated with location 1 on the watch face (e.g., widget 306-1 of watch face 300 or widget 316-1 of watch face 310) and widget 2 setting 422-2 can be associated with location 2 on the watch face (e.g., widget 306-2 of watch face 300 and widget 316-2 of watch face 310).

In some embodiments, value(s) 424-1 can include the user's options and customizations for widget 1 setting 422-1. For example, value(s) 424-1 can define which widget is displayed at location 1 on the watch face (if any), and any settings values for the respective widget, and value(s) 424-2 can define which widget is displayed at location 2 on the watch face (if any), and any settings values for the respective widget. For example, the value(s) 424-1 can include an entry indicating that the respective widget is the temperature widget, the location for which to display the temperature is San Francisco, Calif., and/or other settings or configuration values required to properly configure the temperature watch face in the respective watch face. In some embodiments, value(s) 424-1 provides a watch application with the necessary data to generate a preview image of the respective application (e.g., render, generate or otherwise create a preview image of the respective application) and optionally properly configure the watch face with the respective widget (e.g., if the watch application receives the watch face package as part of a process to install the watch face).

In some embodiments, pre-generated image 426-1 and pre-generated image 426-2 include previews of the widget selected for location 1 and the widget selected for location 2. For example, if the widget selected for location 1 (e.g., for widget 1 setting 422-1) is the temperature widget, then image 426-1 can be an image of the temperature widget displaying a certain temperature. If the widget selected for location 2 (e.g., for widget 2 setting 422-2) is the calendar widget, then image 426-2 can be an image of a particular date with any events scheduled for that date (e.g., such as widget 318 shown in FIG. 3B). In some embodiments, the pre-generated image is pre-generated using the values of the respective setting (by the electronic device or another electronic device). Thus, in some embodiments, the pre-generated image can be the same as an on-demand generated image (e.g., if the preview is generated by the same device that created the watch face package) or can be different (e.g., if the preview is generated by a difference device that has different settings than the device that created the watch face package).

Thus, as discussed above, watch face package 400 can include a plurality of settings that define the visual characteristics (and behaviors) of different portions of a watch face and/or a plurality of pre-generated images that display a preview of the visual characteristic of different portions of the watch face. In some embodiments, a device receiving watch face package 400 can use either the values of respective settings to generate a preview of respective portions of the watch face or use the pre-generated images to display a preview of respective portions of the watch face when generating a full preview of the watch face, depending on various factors such as the context in which the preview is displayed (e.g., whether displayed by a watch application or not) and/or capabilities of the electronic device (e.g., whether certain applications are installed on the device) as will be described in more detail below. For example, if the device is browsing a website that has embedded a watch face into the website, the device can use the pre-generated images of the embedded watch face to render an image of the watch face on the website. In another example, if a device has received a watch face package file via email or text message, the device can render an image of the watch face by using a combination of pre-generated images for certain portions of the watch face and the values of the settings to generate (e.g., on-demand) images for the other portions of the watch face and combining the pre-generated images with the generated images to create an overall image of the watch face.

In some embodiments, generating an image using the values of the settings can include using the application associated with the respective widget to generate a preview of how the respective widget would look if the respective values for the settings were applied. For example, value(s) 424-1 can indicate that widget 1 (e.g., location 1 of the watch face) is populated with the temperature widget (which is associated with the weather application) and the custom font color is red. Thus, the device can use the weather application to generate a preview of how the temperature widget would look like on a typical day using a red font color. Thus, the device (e.g., the watch application installed on the device) is able to use the applications installed on the device itself to generate an on-demand preview of the respective setting. In some embodiments, using the weather application to generate the preview (e.g., as opposed to using the pre-generated image) allows the electronic device to customize the preview for the user's device. For example, the weather application can use the device's current location to display the current temperature at the device's current location (e.g., as opposed to the pre-generated image which optionally displays the temperature at the device at the time that the watch face package was generated). In another example, a calendar application is able to use the actual events on the user's calendar when generating a preview of the calendar widget, thus providing the user with a better preview of how the calendar widget would look on the user's device.

In some embodiments, for settings other than widget settings (e.g., settings that are not associated with an application), generating an image using the values of the settings can include using a native process (e.g., or optionally the watch application) to generate a preview of how the respective widget would look if the respective values for the settings were applied. For example, the device can use a system process (or the watch application) to generate a preview of how the background would look like if the value of the background setting in watch face package 400 is applied.

After generating the previews of the appropriate portions of the watch face, the device can combine the generated images with the image of other portions of the watch face (e.g., other generated images and/or the pre-generated images) to create an overall image of the watch face. For example, device 500 can combine the pre-generated image for widget 1 with an on-demand generated image for widget 2 and pre-generated image of the watch face background to create an overall preview of the watch face.

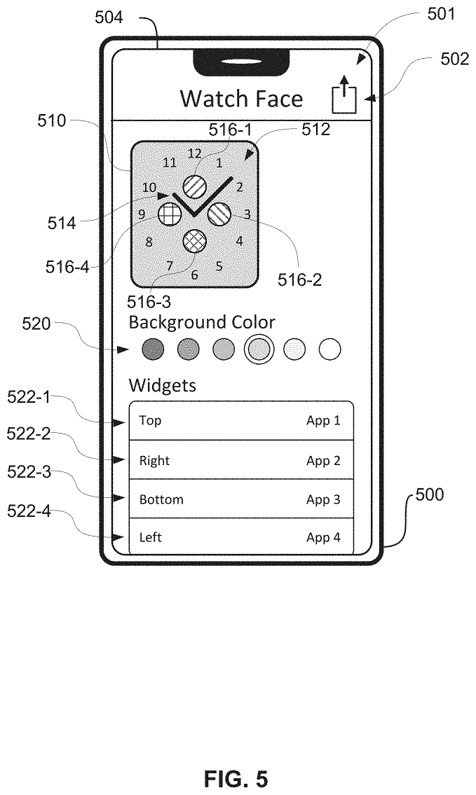

FIG. 5 illustrates exemplary settings for an exemplary watch face 510 according to some examples of the disclosure. In FIG. 5, device 500 (e.g., such as multifunction device 100, mobile telephone 236, digital media player 240, personal computer 244, tablet computing device 248, wearable device 250, etc.) is displaying settings user interface 501 for watch face 510.

In some embodiments, settings user interface 501 is a user interface of a watch application. In some embodiments, a watch application is an application for configuring or otherwise managing the watch faces or other settings for an electronic watch device. For example, the watch application can be an application installed on an electronic device other than an electronic watch device and the electronic device can manage the settings of the electronic watch device using the watch application. In some embodiments, the watch application is an application installed on an electronic watch device (e.g., a system application on the electronic watch device or functionality that is integrated into the settings of the electronic watch device). In some embodiments, as will be described in further detail below, a watch application is able to display (or cause display of) a preview of a watch face by generating the preview on-demand. In some embodiments, generating the preview on-demand includes generating a preview image of the widgets using the corresponding applications. In some embodiments, generating the preview on-demand includes generating a preview using the options that have been set in the watch application (e.g., global settings, local settings, etc.). In some embodiments, applications other than the watch application optionally do not have the ability to generate a preview of a watch face. Thus, as will be described in further detail below, applications other than the watch application (e.g., a messaging application, a browser application, etc.), display previews of a watch face using one or more pre-generated images included in a watch face package. Thus, in some embodiments, an electronic device uses the data stored in a watch face package differently based on the application that is displaying the preview and/or whether the respective application has the ability to generate an on-demand preview of a watch face.

In some embodiments, watch face 510 is similar to and/or shares similar features as watch face 300 described above with respect to FIG. 3A. In some embodiments, settings user interface 501 includes one or more settings to select the visual characteristics and/or widget settings for watch face 510. For example, user interface 501 includes options 520 for setting the background color (e.g., for background 512) of watch face 510. Selecting one of the options from options 520 causes the color of background 512 to be set to the selected color and can cause the corresponding setting (e.g., such as setting 408-1 and/or setting 408-2 described above with respect to FIG. 4) to have a value associated with the selected color (e.g., RGB value, color identifier, etc.). In FIG. 5, user interface 501 includes widget options 522-1 to 522-4. In some embodiments, widget options 522-1 to 522-4 are associated with widgets 516-1 to 516-4 of watch face 510 and define the widget to be displayed at the respective location. For example, widget option 522-1 corresponding to the “top” location (e.g., the location of widget 516-1) is set to display the widget associated with App 1, widget option 522-2 corresponding to the “right” location (e.g., the location of widget 516-2) is set to display the widget associated with App 2, widget option 522-3 corresponding to the “bottom” location (e.g., the location of widget 516-3) is set to display the widget associated with App 3, and widget option 522-4 corresponding to the “left” location (e.g., the location of widget 516-4) is set to display the widget associated with App 4. In some embodiments, any of the widget options can be not populated (in which case the corresponding settings option in the watch face package can be empty and/or null) and in some embodiments, an application can be displayed in multiple widget locations.

It is understood that the settings displayed in user interface 501 are merely exemplary and different number and different types of settings are possible for customizing the look and/or customizing the widgets for a watch face. For example, a watch face can include a setting for customizing the type of background (e.g., solid color, patterned color, custom image, slideshow, etc.), a setting for uploading a custom image for the background, etc. A watch face can also include more or fewer widget options than those illustrated in FIG. 5.

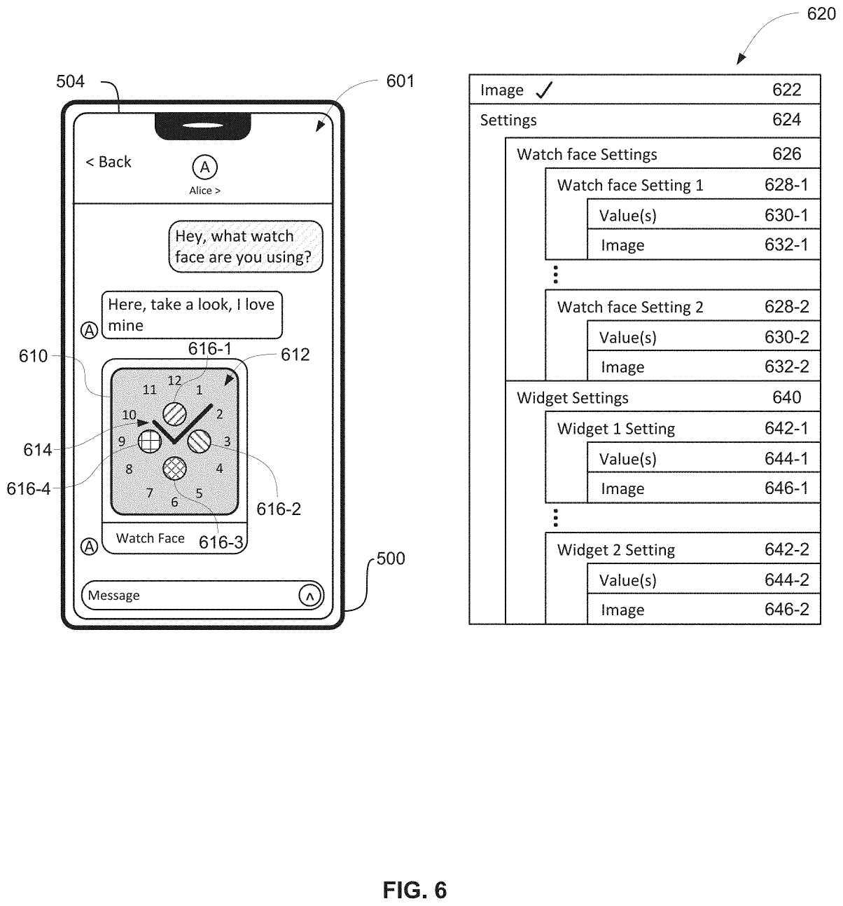

FIG. 6 illustrates an exemplary display of a preview of watch face 610 according to some examples of the disclosure. FIG. 6 also illustrates an exemplary watch face package 620 corresponding to watch face 610. In FIG. 6, device 500 is displaying a text message user interface 601. As shown, a user is able to share a watch face (e.g., watch face 610) with another user by transmitting a watch face package over a communication channel, such as a text message (e.g., SMS, MIMS, etc.). As shown in FIG. 6, when device 500 receives watch face package 620, device 500 can display a preview of the corresponding watch face. In some embodiments, the preview of the watch face provides the user with a preview of how the watch face looks and/or how the watch face would look when installed on the user's device (e.g., the user's electronic watch device).

In some embodiments, the preview displayed by device 500 is based on the data stored in watch face package 620. As shown in FIG. 6, watch face package 620 includes one or more settings that define the settings and customizations associated with the watch face and one or more pre-generated images that display a preview of corresponding portions of the watch face. In FIG. 6, pre-generated image 622 corresponding to the overall preview image of watch face 610 is used by device 500 to display a preview of watch face 610. For example, the preview of watch face 610 displayed in user interface 601 is the same image as pre-generated image 622 from watch face package 620. Thus, device 500 is able to retrieve pre-generated image 622 from watch face package 620 and display pre-generated image 622 in user interface 601 as a preview of watch face 610. In such embodiments, device 500 generating an image of watch face 610 using the values of the settings in watch face package 620.

In some embodiments, instead of using pre-generated image 622 to display the overall preview of watch face 610, device 500 can use each of the pre-generated images in watch face package 620 (e.g., pre-generated images 632-1, 632-2, 646-1, 646-2, etc.) in combination to create the overall preview of watch face 610. Thus, in some embodiments, watch face package 620 does not include pre-generated image 622.

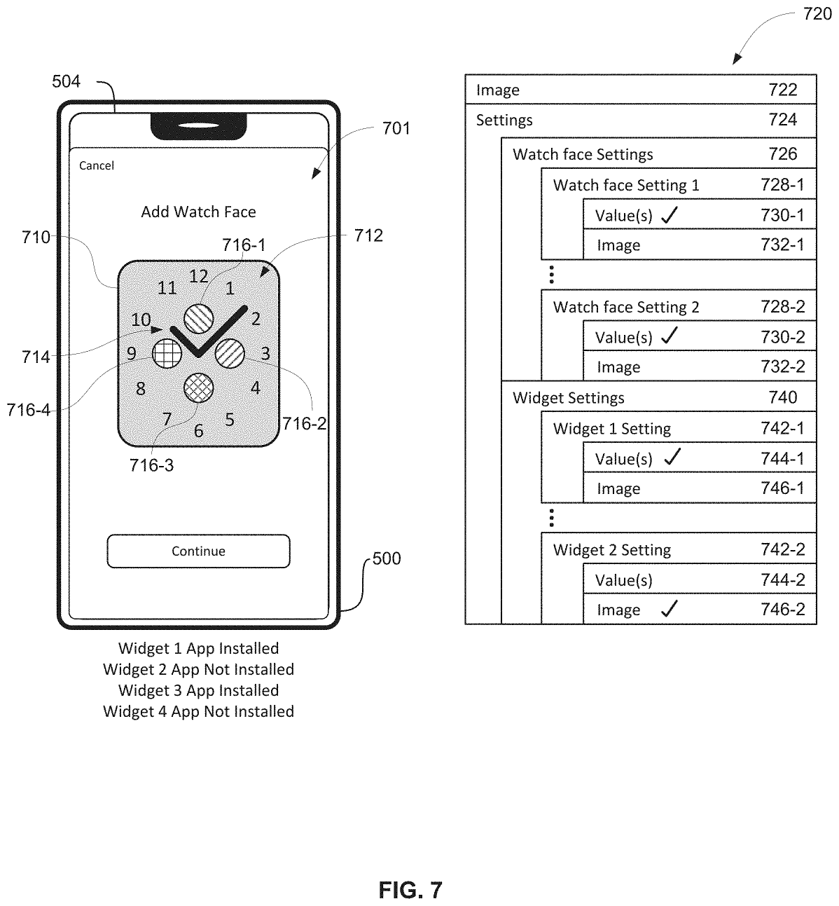

FIG. 7 illustrates an exemplary display of a preview of a watch face 710 according to some examples of the disclosure. In FIG. 7, device 500 is displaying user interface 701 associated with a process to add (e.g., install) watch face 710 onto device 500 (and/or onto an electronic watch device in communication with device 500). In some embodiments, user interface 701 is a user interface of a watch application (e.g., an application for configuring or otherwise managing the watch faces or other settings for an electronic watch device). In some embodiments, the process to add watch face 710 onto device 500 is initiated in response to a request to add watch face 710 onto device 500. For example, downloading watch face package 720 is performed in response to selecting the preview of a watch face from a messenger user interface (e.g., such as in FIG. 6), selecting a hyperlink on a website, receiving the watch face package via a direct messaging service such as NFC, scanning a QR code that directs the user to a watch face package, etc.

As shown in FIG. 7, watch face package 720 corresponding to watch face 710 has been downloaded onto device 500 and device 500 has begun the process of adding watch face 710 to device 500. In some embodiments, device 500 is a mobile device that is in communication with an electronic watch device (e.g., such as wearable device 250). In some embodiments, device 500 is able to configure the electronic watch device including setting the active watch face for the electronic watch device and modifying and/or customizing watch faces. Thus, adding watch face 710 to device 500 optionally allows watch face 710 to be selected as the active watch face for an electronic watch device.

In FIG. 7, device 500 displays a preview of watch face 710. In FIG. 7A, watch face 710 includes background 712, watch hands 714, and widgets 716-1 to 716-4 (e.g., similar to watch face 300, watch face 510, and watch face 610). In some embodiments, the preview of watch face 710 is generated by combining the previews of individual portions of the watch face (e.g., a preview of widget 716-1, a preview of background 712, etc.) into a single preview image (e.g., the single preview image is a mosaic of images of the different visual elements of the watch face). In some embodiments, the previews of individual portions of the watch face can be the pre-generated images included in watch face package 720, or can be generated (e.g., rendered) images generated by device 500 based on the values of respective settings included in watch face package 720.

In some embodiments, whether device 500 uses the pre-generated images or generates the images itself depends on whether applications associated with the respective portions of the watch face are installed and/or available to generate the image. For example, as described above, widgets can be associated with an application and display information provided by the application. Thus, to generate a preview of the widget, the associated application optionally is required to be installed on device 500 such that device 500 can use the associated application to generate the visuals of the widget.

In some embodiments, the context in which the preview is displayed can determine whether to use pre-generated images or whether to generate the images. For example, in FIG. 6, device 500 used the pre-generated images for all portions of the watch face and did not generate images for any of the portions of the watch face, optionally because the user has not shown an intention to install watch face 610 onto device 500 (e.g., watch face 610 is displayed outside of the process to install the watch face). In some embodiments, generating images using the settings in the watch face package is only performed for previews of the respective watch face when the device is in the process of installing the watch face onto the device. In some embodiments, generating images using the settings of the watch face package is only performed when displaying a preview of the watch face in an application for managing watch faces for the electronic watch device (e.g., such as the application associated with user interface 701). In some embodiments, the device can generate images using the settings in the watch face package regardless of context (e.g., any time a preview of the watch face is displayed).

Returning back to FIG. 7, device 500 has the application associated with widget 1 and the application associated with widget 3 installed and does not have the application associated with widget 2 or the application associated with widget 4 installed. In some embodiments, the electronic watch device that device 500 is in communication with also has the application associated with widget 1 and the application associated with widget 3 installed and does not have the application associated with widget 2 or the application associated with widget 4 installed. Thus, as shown in FIG. 7, device 500 is able to use the application associated with widget 1 and the application associated with widget 3 to generate a preview image of widget 1 (e.g., widget 716-1) and a preview image of widget 3 (e.g., widget 716-3). As illustrated in watch face package 720, device 500 uses the values 744-1 for widget 1 setting 744-1 to generate the preview of widget 1 (e.g., widget 716-1), but uses the pre-generated image 746-2 as the preview of widget 2 (e.g., widget 716-2). In FIG. 7, device 500 does not use pre-generated image 746-1 as a preview of widget 1, and does not use value(s) 744-2 to generate the preview of widget 2. In some embodiments, the resulting image generated by using the values can be different or the same as the pre-generated image included in watch face package 720. Thus, the preview of certain widgets can use pre-generated images while the preview of other widgets can be generated by device 500 (e.g., device 500 can use only generated previews, use only pre-generated previews, or a mix of the two).

In some embodiments, using the values of the settings includes transmitting the values to the application associated with the widget and receiving, from the application, an image based on the values provided to the application. For example, as described above, the value of the settings can indicate that widget 1 is a temperature widget, that the associated application is the weather application, that the font color should be red, that the widget should be displayed in a circular or “small” mode, and/or that the widget will be placed in the “top” widget location. Based on these values, device 500 can transmit a command or request to the weather application to generate a preview of a temperature widget in a circular and/or “small” mode with red font. Using these received settings, the weather application on device 500 can generate a representative image of how the temperature widget would look when placed at the “top” widget location (e.g., with red font and in a circular or “small” mode). Device 500 can then use the generated representative image and combine it with images of other portions of the watch face (e.g., the pre-generated image 746-2 for widget 2, a generated representative image of widget 3, the pre-generated image for widget 4, etc.) to construct the single representative image of watch face 710.

As described above, in some embodiments, watch face settings 726 are associated with settings for watch face 710 that are not associated with an application. For example, background settings, time indicator settings, watch dial settings, etc. Thus, in some embodiments, whether device 500 uses the pre-generated images for these settings or generates a preview using the values of the settings does not depend on whether particular applications are installed on device 500. In some embodiments, the settings are associated with native or system processes that are available on device 500 without requiring the installation of a particular application. Thus, in some embodiments, when generating a preview of watch face 710, device 500 uses the values of the watch face settings to generate a preview for the respective portions of the watch face. As shown in FIG. 7, value 730-1 for watch face setting 1 728-1 is used to generate a preview of the portion of watch face 710 associated with watch face setting 1 728-1 (e.g., background 712), and value 730-2 for watch face setting 2 728-2 is used to generate a preview of the portion of watch face 710 associated with watch face setting 2 728-2 (e.g., watch hands 714). In FIG. 7, pre-generated images 732-1 and 732-2 are not used as the preview of the respective portions of watch face 710. In some embodiments, after all respective portions of watch face 710 have been generated, device 500 combines the respective portions to construct a single representative image of watch face 710.

It is understood that although the example illustrated in FIG. 7 shows device 500 using the values to generate a preview for watch face setting 1 728-1, watch face setting 2 728-2, and widget 1, and using the pre-generated image 746-2 for widget 2, this is merely exemplary and device 500 is not limited to only this combination. For example, device 500 can use either the values to generate a preview or the pre-generated image for any portion of watch face 710. For example, device 500 can use the pre-generated images (e.g., pre-generated image 732-1 and pre-generated image 732-2) for watch face settings, rather than generating a preview even if device 500 has the means to generate a preview, or device 500 can use the pre-generated images for widget, even though device 500 has the means to generate a preview of the widgets (e.g., even if the device has the associated applications installed).

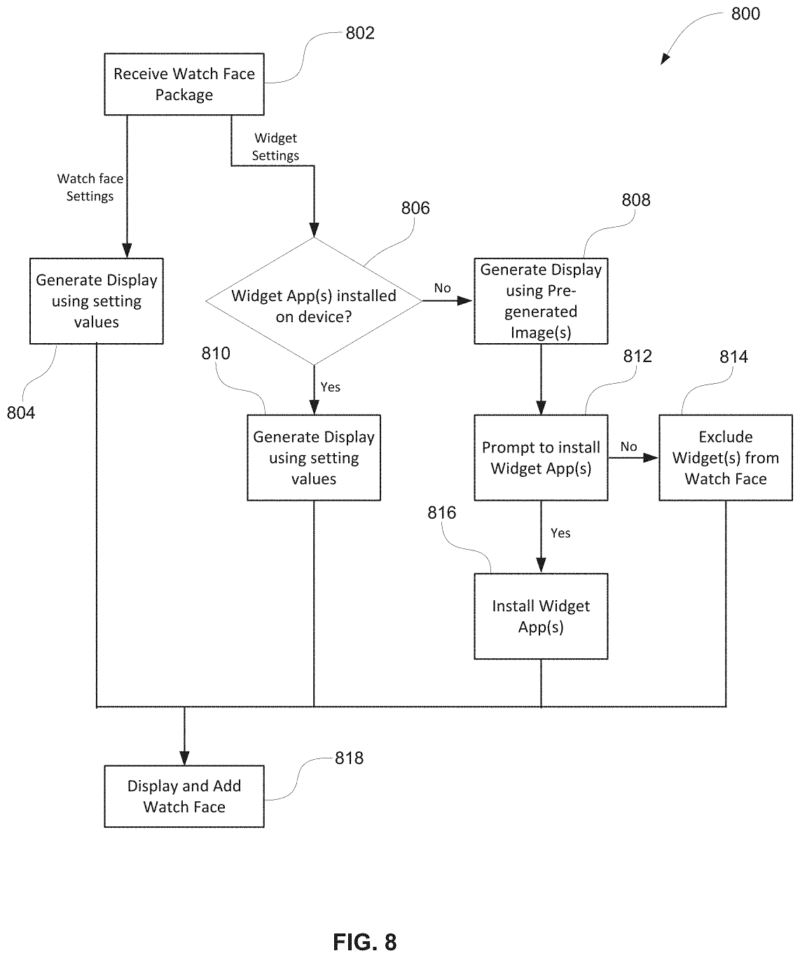

FIG. 8 illustrates an exemplary method 800 of displaying a preview of a watch face according to some examples of the disclosure. In FIG. 8, at step 802, a device (e.g., such as multifunction device 100, mobile telephone 236, digital media player 240, personal computer 244, tablet computing device 248, wearable device 250, device 500, etc.) receives a watch face package (e.g., such as watch face package 400). In some embodiments, a device receives a watch face package by downloading a watch face package onto the device (e.g., downloading the watch face package from a website, from an application, from a messaging service, via direct transfer such as NFC). In some embodiments, a device receives a watch face package when displaying a user interface in which a watch face package is embedded (e.g., a website that includes code for embedding a preview of a watch face). Thus, in some embodiments, a device can receive a watch face package and display a preview of the respective watch face without having initiated a process to install (e.g., add) the watch face onto the device.

At step 802, the device determines the set of settings that are associated with widgets (e.g., widget settings) and the set of settings that are not associated with widgets (e.g., watch face settings). In some embodiments, watch face settings are processed differently than widget settings. In some embodiments, watch face settings are not processed differently than widget settings (e.g., widget settings are treated the same as watch face settings or watch face settings are treated the same as widget settings).

At step 804, the device generates the preview of the respective portions of the watch face associated with the respective watch face settings using the values for the settings included in the watch face package. For example, the device sends the settings values to the appropriate device process and generates a representative image of how the respective portion of the watch face would look when the settings values are applied.

At step 806, the device determines, based on the set of widget settings, whether the applications associated with the respective widgets have been installed on the device. For example, a first widget location can be populated with a first widget, which is associated with a first application and the device determines whether the first application is installed on the device. In some embodiments, if a widget location is not populated with a widget, then the device forgoes determining whether an application associated with the respective widget location is installed on the device (e.g., because there is no associated application).

At step 810, if the respective application associated with a respective widget is installed on the device, then the device generates the preview of the respective portion of the watch face associated with the respective widget using the values for the widget setting included in the watch face package (optionally using the respective application to generate the preview as described above). In some embodiments, the device does not use the pre-generated images that are included in the watch face package.

At step 808, if the respective application associated with a respective widget is not installed on the device, then the device generates the preview of the respective portion of the watch face by using the pre-generated image associated with the respective widget that is included in the watch face package. In some embodiments, the device does not use the values for the widget setting included in the watch face package to generate the preview of the respective widget.

In some embodiments, if process 800 is not a part of a process to install a watch face on a device (e.g., is only part of a process to display a preview of a watch face), then process 800 continues to step 818 to generate the overall preview of the watch face, as will be described in further detail below.

In some embodiments, if process 800 is performed as part of a process to install a watch face on a device, then process 800 continues to step 812. In some embodiments, at step 812, in accordance with a determination that the respective application is not installed on the device, the device prompt the user to install the respective application associated with the widget. In some embodiments, if the respective application associated with the respective widget is not installed on the device (or optionally if the respective application is not installed on the electronic watch device), then the electronic watch device is not able to display the widget at the respective location on the watch face (e.g., there is no information to display, there is no application to generate the display, etc.). For example, if the weather application is not installed on the device, then the temperature widget associated with the weather application cannot be used on the watch face and thus the device can prompt the user to download the weather application onto the device so that the temperature widget can be used.

At step 816, if the user assents to installing the respective application, then the device initiates a process to install the respective application onto the device. In some embodiments, the process includes displaying an application store, purchasing the respective application, downloading the application, and/or installing the application. In some embodiments, after installing the respective application, the device preserves the respective widget in the watch face. For example, if the user downloads and installs the weather application, then the device maintains the temperature widget on the watch face. If, however, the user does not download or install the weather application, then the device removes the temperature widget from the watch face, as will be described below with respect to step 814. In some embodiments, if method 800 is performed on an electronic watch device, then at step 816, the respective application is installed on the electronic watch device. In some embodiments, if method 800 is performed on an electronic device other than an electronic watch device, but the electronic device is configured to manage an electronic watch device (e.g., the electronic device is in communication with the electronic watch device and is able to control the settings of the electronic watch device), then installing the respective application includes installing the application on the electronic watch device and optionally includes installing the application on the electronic device.

At step 814, if the user declines to install the application associated with the widget, then the device removes from respective widget from the watch face to be added to the device. In some embodiments, removing the respective widget includes removing the entry in the watch face package associated with the respective widget (or optionally zero-ing or null-ing the respective entries). In some embodiments, removing the respective widget includes masking the entries in the watch face package associated with the respective widget or ignoring the entries in the watch face package associated with the respective widget (optionally no widget is placed at the location of the respective location).

It is understood that steps 806-816 can be performed for each widget included in the watch face package to generate the preview image for each widget. Thus, in some embodiments, the process to install a watch face on a device can cause multiple applications to be installed on the device. In some embodiments, an application can be associated with multiple widgets such that two or more widgets on a watch face can correspond to the same application. For example, a weather application can have a temperature widget that displays the current temperature and a forecast widget that displays the upcoming weather forecast. Thus, if the device determines that two or more widgets correspond to the same application, then the user is only prompted to download the respective application once such that if the user assents to downloading the respective application, both widgets are included whereas if the user declines to download the respective application, neither widget is included).

At step 818, after all portions of the watch face have been processed by the device, the device combines all of the previews of respective portions of the watch face (e.g., either generated previews as in step 804 and 810, or using pre-generated images as in step 808) into a single overall preview of the entire watch face.

In some embodiments, if process 800 is performed as part of a process to install a watch face on a device, then at step 818, the device installs the watch face onto the device. In some embodiments, widgets whose associated applications were not installed on the device (e.g., as in step 814) are excluded from the installed watch face (e.g., the installed watch face is excluded from the watch face that is installed onto the device). In some embodiments, installing the watch face onto the device allows a user to select the watch face as the active watch face to be used by an electronic watch device (e.g., wearable device 250). In some embodiments, the installed watch face can be edited or otherwise customized or modified by the user after installation on the device (e.g., the installed watch face is not fixed to its original settings).

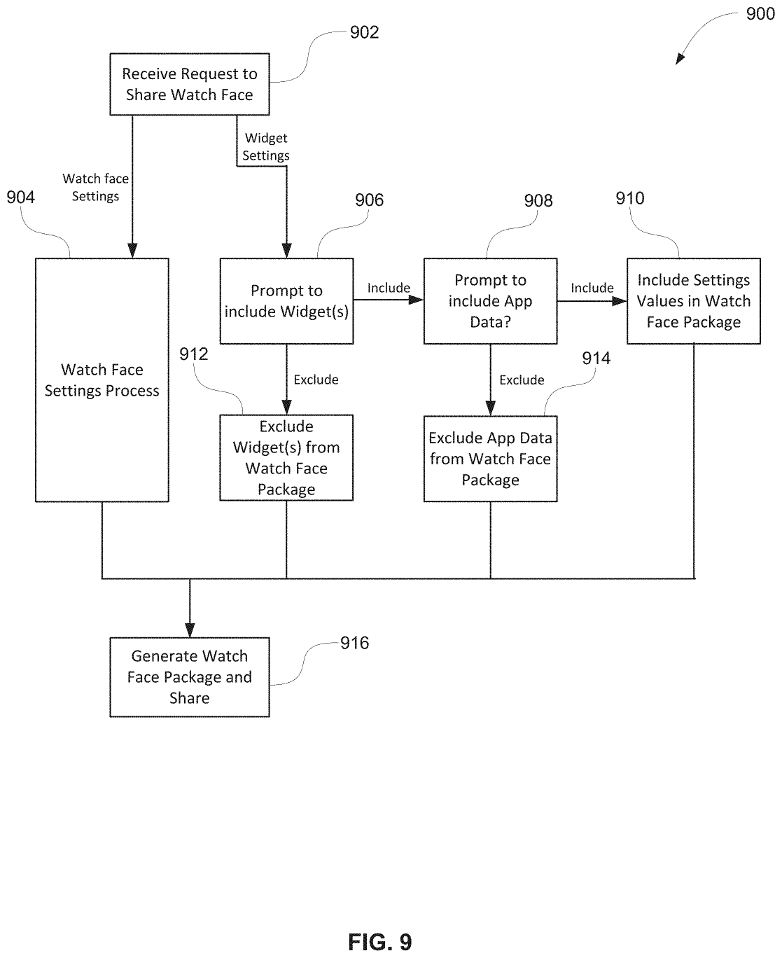

FIG. 9 illustrates an exemplary method 900 of generating a watch face package according to some examples of the disclosure. In some embodiments, a device (e.g., such as multifunction device 100, mobile telephone 236, digital media player 240, personal computer 244, tablet computing device 248, wearable device 250, device 500, etc.) is able to generate a watch face package based on a watch face that is installed on the device (or installed on an electronic watch device with which the device is in communication). In some embodiments, the generated watch face package can be transmitted to another electronic device to share the watch face with the other electronic device (the recipient electronic device can optionally perform process 800 described above with respect to FIG. 8 in response to receiving the watch face package).

At step 902, the device receives a request to share a respective watch face. For example, if a user selects a share affordance associated with a respective watch face (e.g., such as share affordance 502 associated with watch face 510 shown in FIG. 5). In some embodiments, in response to the request to share the watch face, the device determines the set of settings that are associated with widgets (e.g., widget settings) and the set of settings that are not associated with widgets (e.g., watch face settings). In some embodiments, watch face settings are processed differently than widget settings. In some embodiments, watch face settings are not processed differently than widget settings (e.g., widget settings are treated the same as watch face settings or watch face settings are treated the same as widget settings).

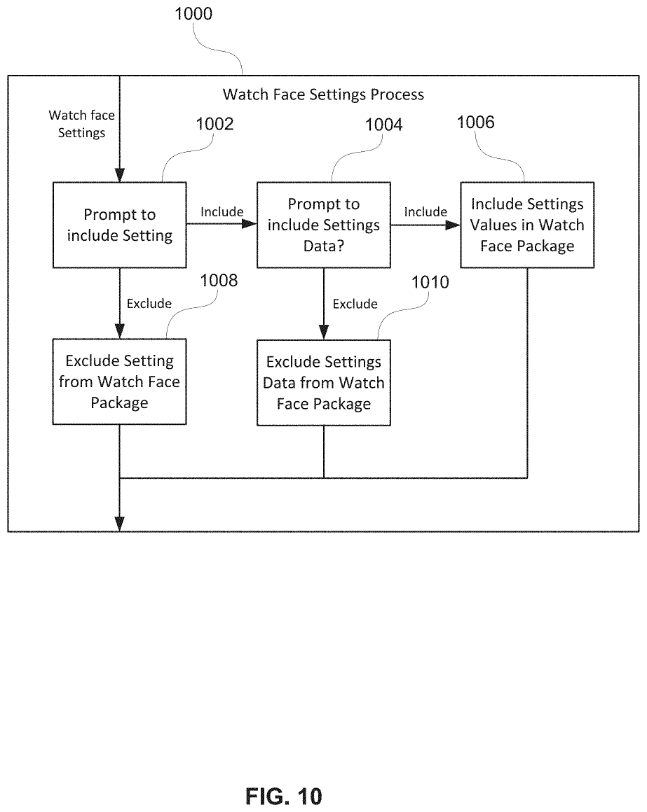

At step 904, the device processes the watch face settings as will be described in further detail below in FIG. 10 with respect to method 1000. At step 906, for each widget, the device prompts the user whether to include the respective widget in the watch face package. For example, a user is able to exclude or include individual widgets from the generated watch face package. For example, if the watch face that the user is requesting to share includes a temperature widget, but the user wishes not to include the temperature widget in the shared watch face, the user is able to exclude the temperature widget from the resulting watch face package. In some embodiments, at step 912, if the user chooses to exclude a widget, then the widget is excluded from the watch face package. For example, entries associated with the excluded widget are optionally left empty (e.g., a null value) or the settings associated with the respective location on the watch face optionally indicates that no widget is located there.

In some embodiments, if user does not opt to exclude the respective widget (optionally if the user opts to include the respective widget), the respective widget is added to the watch face package (e.g., an entry associated with the respective widget is generated and/or the entry associated with the location of the widget indicates that the location includes the respective widget). In some embodiments, adding the respective widget to the watch face package includes generating a preview image of the respective widget and including the preview image in the watch face package (e.g., as a pre-generated image entry, such as pre-generated images 426-1 and 426-2). In some embodiments, at step 908, and the user is prompted whether to include or exclude application data associated with the respective widget from the watch face package. In some embodiments, application data includes one or more of data or metadata of the application associated with the respective widget (e.g., user data, user-provided data, personally identifiable data, data associated with a user, etc.). For example, app data for a temperature widget can include the current location of the user's device. In another example, app data for a calendar widget can include the events that are scheduled on the user's calendar. Thus, a user may desire to exclude some or all of the app data from the watch face package.

At step 914, if the user chooses to exclude app data from the watch face package, then the device filters the data that otherwise would be included in the watch face package and excludes the app data from being included in the watch face package. For example, the values for the settings of the respective widget (e.g., values 424-1, values 424-4, etc. described above in FIG. 4) can not include some or all of the application data associated with the respective widget. In some embodiments, excluding the application data from the watch face package can include modifying the pre-generated image of the respective portions to remove indications of the app data that has been removed. For example, a pre-generated image of the temperature widget whose app data is removed can optionally not display the current location of the device and a pre-generated image of a calendar widget whose app data is removed can optionally not display the events scheduled on the user's calendar.

At step 910, if the user chooses to include app data from the watch face package (or optionally if the users chooses not to exclude app data from the watch face package), then some or all of the application data associated with the widget is included in the watch face package (e.g., in an entry associated with the widget, such as values 424-1 and values 424-2 described above in FIG. 4).

It is understood that steps 906-914 can be performed for each widget included in the watch face. At step 916, after all portions of the watch face have been processed for inclusion or exclusion in the watch face package, the device generates the watch face package and shares the watch face package. In some embodiments, generating the watch face package includes creating a watch face file that includes the watch face package described above. In some embodiments, sharing the watch face package includes transmitting the watch face file that includes the watch face package to another electronic device. For example, attaching the watch face package to an email, uploading the watch face package to a server, texting the watch face package to another user, etc.

FIG. 10 illustrates an exemplary method 1000 of generating a watch face package according to some examples of the disclosure. In some embodiments, method 1000 is a method of processing the watch face settings (e.g., settings for a watch face other than widget settings) for inclusion in a watch face package, similar to step 904 described above with respect to FIG. 9.

At step 1002, for each watch face setting, the device prompts the user whether to include the respective watch face setting in the watch face package. For example, a user is able to exclude or include individual settings from the generated watch face package. For example, fi a watch face has a certain setting for the background, but the user wishes not to include the background in the shared watch face, the user is able to exclude the background settings from the resulting watch face package. In some embodiments, at step 1008, if the user chooses to exclude a setting, then the setting is excluded from the watch face package. For examples, entries associated with the excluded setting is optionally left empty (e.g., a null value).

In some embodiments, if the user does not opt to exclude the watch face setting (optionally if he user opts to include the watch face setting), the respective watch face setting is added to the watch face package (e.g., an entry associated with the setting is generated and/or populated with the respective values). In some embodiments, adding the respective watch face setting to the watch face package includes generating a preview image of the respective portion of the watch face and including the preview image in the watch face package (e.g., as a pre-generated image entry, such as pre-generated images 412-1 and 412-2). In some embodiments, at step 1004, and the user is prompted whether to include or exclude settings data associated with the respective watch face setting from the watch face package. In some embodiments, settings data includes one or more of data or metadata associated with the respective watch face setting. For example, settings data for a background can include the image or images that the user is using as the background. Thus, a user may desire to exclude some or all of the settings data from the watch face package.

At step 1010, if the user chooses to exclude settings data from the watch face package, then the device filters the data that otherwise would be included in the watch face package and excludes the settings data from being included in the watch face package. For example, the values for the settings of the respective watch face setting (e.g., values 410-1, values 410-4, etc. described above in FIG. 4) can not include some or all of the settings data associated with the respective watch face setting. In some embodiments, excluding the settings data from the watch face package can include modifying the pre-generated image of the respective portions to remove indications of the settings data that has been removed. For example, a pre-generated image of the background whose settings data is removed can optionally not display the user's image that is being used as the background.

At step 1006, if the user chooses to include settings data from the watch face package (or optionally if the users chooses not to exclude settings data from the watch face package), then some or all of the settings data associated with the watch face setting is included in the watch face package (e.g., in an entry associated with the watch face setting, such as values 410-1 and values 410-2 described above in FIG. 4).

Therefore, according to the above, some examples of the disclosure are directed to a method. In some examples, the method is performed at an electronic device. In some examples, the method includes receiving a watch face package, the watch face package including one or more definitions of visual characteristics of one or more portions of a respective watch face. In some examples, a respective definition corresponding to a respective portion of the watch face includes first display data associated with the respective portion of the watch face, and second display data associated with the respective portion of the watch face. In some examples, the first display data defines a pre-generated appearance of a visual characteristic of the respective portion of the watch face and the second display data defines a second appearance of the visual characteristic of the respective portion of the watch face.

In some examples, additionally or alternatively, the method includes, after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance. In some examples, additionally or alternatively, the one or more portions of the respective watch face include one or more visual elements configured to display information from one or more respective applications.

In some examples, additionally or alternatively, the respective portion of the watch face corresponds to a respective visual element of the one or more visual elements configured to display information from a respective application. In some examples, additionally or alternatively, the one or more criteria include a requirement that the respective application is installed on the electronic device. In some examples, additionally or alternatively, generating the second appearance of the visual characteristic of the respective portion of the respective watch face includes generating the second appearance using the respective application installed on the electronic device.

In some examples, additionally or alternatively, the method includes after receiving the watch face package, in accordance with a determination that the one or more criteria are not satisfied because the requirement that the respective application be installed on the electronic device is not satisfied, displaying, at the electronic device, the pre-generated appearance of the visual characteristic of the respective portion of the respective watch face using the first display data associated with the respective portion of the watch face, and without using the respective application.

In some examples, additionally or alternatively, the method includes in accordance with a determination that the requirement that the respective application be installed on the electronic device is not satisfied, receiving a user input corresponding to the respective application. In some examples, additionally or alternatively, the method includes, in response to the user input, in accordance with a determination that the user input corresponds to a request to download the respective application, initiating a process to download the respective application, and in accordance with a determination that the user input does not correspond to the request to download the respective application, initiating a process to install the watch face package on the electronic device without the respective visual element.

In some examples, additionally or alternatively, a second respective portion of the watch face corresponds to a second respective visual element of the one or more visual elements configured to display information from a second respective application. In some examples, additionally or alternatively, the method includes, in accordance with a determination that a requirement that the second respective application be installed on the electronic device is not satisfied, receiving a second user input corresponding to the second respective application. In some examples, additionally or alternatively, the method includes, in response to the second user input, in accordance with a determination that the user input corresponds to a request to download the second respective application, initiating a process to download the second respective application, and in accordance with a determination that the user input does not correspond to the request to download the second respective application, initiating the process to install the watch face package on the electronic device without the second respective visual element.

In some examples, additionally or alternatively, the watch face package is received from a source external to the electronic device. In some examples, additionally or alternatively, the method includes, before receiving the watch face package, displaying a preview of the respective watch face, wherein displaying the preview includes displaying, at the electronic device, the pre-generated appearance of the visual characteristic of the respective portion of the respective watch face using the first display data associated with the respective portion of the watch face, without generating the pre-generated appearance.

In some examples, additionally or alternatively, the method includes after receiving the watch face package, initiating a process to install the watch face package on the electronic device, wherein after installing the watch face package on the electronic device, the respective watch face is available to be used at a respective electronic device.

In some examples, additionally or alternatively, the method includes initiating a process to generate, at the electronic device, a second watch face package for sharing with a second electronic device, the second watch face package corresponding to a second watch face installed on the electronic device, wherein the process to generate the second watch face package includes providing one or more options to exclude one or more definitions of one or more portions of the second watch face from the second watch face package.

In some examples, additionally or alternatively, the process to generate the second watch face package includes excluding personal data associated with a user of the electronic device from the second watch face package.

Some examples of the disclosure are directed to a non-transitory computer readable storage medium storing one or more programs configured for execution by one or more processors of an electronic device. In some examples, the one or more programs comprising instructions for: receiving a watch face package, the watch face package including one or more definitions of visual characteristics of one or more portions of a respective watch face and after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance. In some examples, a respective definition corresponding to a respective portion of the watch face includes first display data associated with the respective portion of the watch face, and second display data associated with the respective portion of the watch face. In some examples, the first display data defines a pre-generated appearance of a visual characteristic of the respective portion of the watch face and the second display data defines a second appearance of the visual characteristic of the respective portion of the watch face.

Some examples of the disclosure are directed to an electronic device. In some examples, the electronic device comprises one or more processors; memory; and one or more programs, wherein the one or more programs are stored in the memory and are configured for execution by the one or more processors. In some examples, the one or more programs comprises instructions for: receiving a watch face package, the watch face package including one or more definitions of visual characteristics of one or more portions of a respective watch face and after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance. In some examples, a respective definition corresponding to a respective portion of the watch face includes first display data associated with the respective portion of the watch face, and second display data associated with the respective portion of the watch face. In some examples, the first display data defines a pre-generated appearance of a visual characteristic of the respective portion of the watch face and the second display data defines a second appearance of the visual characteristic of the respective portion of the watch face.

As described above, one aspect of the present technology is the gathering and use of data available from specific and legitimate sources to improve the display of information to users. The present disclosure contemplates that in some instances, this gathered data may include personal information data that uniquely identifies or can be used to identify a specific person. Such personal information data can include photographs, demographic data, location-based data, online identifiers, telephone numbers, email addresses, home addresses, calendar events, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to display the user's current location, display the user's scheduled appointments, and/or the user's photographs, etc. Accordingly, use of such personal information data enables users to have more information. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable or share personal information. In yet another example, users can select to limit the sharing of personal information or entirely block the sharing of personal information, such as via method 900 and/or method 1000 described above. In addition to providing “opt in” and “opt out” options, the present disclosure contemplates providing notifications relating to the access or use of personal information. For instance, a user may be notified upon generating a watch face package that personal information may be used and then reminded again before sharing a watch face package.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, information can be generated and delivered to users based on non-specific information data or a bare minimum amount of identifying information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A method comprising:
at an electronic device:
receiving a watch face package, the watch face package including one or more definitions of visual characteristics of one or more portions of a respective watch face, wherein a respective definition corresponding to a respective portion of the watch face includes:
first display data associated with the respective portion of the watch face, wherein the first display data defines a pre-generated appearance of a visual characteristic of the respective portion of the watch face; and
second display data associated with the respective portion of the watch face, wherein the second display data defines a second appearance of the visual characteristic of the respective portion of the watch face; and
after receiving the watch face package:
in accordance with a determination that one or more criteria are satisfied, generating, at the electronic device, the second appearance of the visual characteristic of the respective portion of the respective watch face using the second display data associated with the respective portion of the watch face.

2. The method of claim 1, further comprising:
after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance.

3. The method of claim 1, wherein the one or more portions of the respective watch face include a background portion of the respective watch face, one or more hands of the respective watch face, or one or more time indicators of the respective watch face.

4. The method of claim 1, wherein the one or more portions of the respective watch face include one or more visual elements configured to display information from one or more respective applications.

5. The method of claim 4, wherein:
the respective portion of the watch face corresponds to a respective visual element of the one or more visual elements configured to display information from a respective application;
the one or more criteria include a requirement that the respective application is installed on the electronic device;
generating the second appearance of the visual characteristic of the respective portion of the respective watch face includes generating the second appearance using the respective application installed on the electronic device, the method further comprising:
after receiving the watch face package, in accordance with a determination that the one or more criteria are not satisfied because the requirement that the respective application be installed on the electronic device is not satisfied, displaying, at the electronic device, the pre-generated appearance of the visual characteristic of the respective portion of the respective watch face using the first display data associated with the respective portion of the watch face, and without using the respective application.

6. The method of claim 5, further comprising:
in accordance with a determination that the requirement that the respective application be installed on the electronic device is not satisfied:
receiving a user input corresponding to the respective application; and
in response to the user input:
in accordance with a determination that the user input corresponds to a request to download the respective application, initiating a process to download the respective application; and
in accordance with a determination that the user input does not correspond to the request to download the respective application, initiating a process to install the watch face package on the electronic device without the respective visual element.

7. The method of claim 6, wherein a second respective portion of the watch face corresponds to a second respective visual element of the one or more visual elements configured to display information from a second respective application, the method further comprising:
in accordance with a determination that a requirement that the second respective application be installed on the electronic device is not satisfied:
receiving a second user input corresponding to the second respective application; and
in response to the second user input:
in accordance with a determination that the user input corresponds to a request to download the second respective application, initiating a process to download the second respective application; and
in accordance with a determination that the user input does not correspond to the request to download the second respective application, initiating the process to install the watch face package on the electronic device without the second respective visual element.

8. The method of claim 1, wherein the watch face package is received from a source external to the electronic device.

9. The method of claim 1, further comprising:
before receiving the watch face package, displaying a preview of the respective watch face, wherein displaying the preview includes displaying, at the electronic device, the pre-generated appearance of the visual characteristic of the respective portion of the respective watch face using the first display data associated with the respective portion of the watch face, without generating the pre-generated appearance.

10. The method of claim 1, further comprising:
after receiving the watch face package:
initiating a process to install the watch face package on the electronic device, wherein after installing the watch face package on the electronic device, the respective watch face is available to be used at a respective electronic device.

11. The method of claim 1, further comprising:
initiating a process to generate, at the electronic device, a second watch face package for sharing with a second electronic device, the second watch face package corresponding to a second watch face installed on the electronic device, wherein the process to generate the second watch face package includes providing one or more options to exclude one or more definitions of one or more portions of the second watch face from the second watch face package.

12. The method of claim 11, wherein the process to generate the second watch face package includes excluding personal data associated with a user of the electronic device from the second watch face package.

13. An electronic device, comprising:
one or more processors;
memory; and
one or more programs, wherein the one or more programs are stored in the memory and are configured for execution by the one or more processors, the one or more programs comprising instructions for:
receiving a watch face package, the watch face package including one or more definitions of visual characteristics of one or more portions of a respective watch face, wherein a respective definition corresponding to a respective portion of the watch face includes:
first display data associated with the respective portion of the watch face, wherein the first display data defines a pre-generated appearance of a visual characteristic of the respective portion of the watch face; and
second display data associated with the respective portion of the watch face, wherein the second display data defines a second appearance of the visual characteristic of the respective portion of the watch face; and
after receiving the watch face package:
in accordance with a determination that one or more criteria are satisfied, generating, at the electronic device, the second appearance of the visual characteristic of the respective portion of the respective watch face using the second display data associated with the respective portion of the watch face.

14. The electronic device of claim 13, wherein the one or more programs further include instructions for:
after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance.

15. The electronic device of claim 13, wherein the one or more portions of the respective watch face include one or more visual elements configured to display information from one or more respective applications.

16. The electronic device of claim 15, wherein:
the respective portion of the watch face corresponds to a respective visual element of the one or more visual elements configured to display information from a respective application;
the one or more criteria include a requirement that the respective application is installed on the electronic device;
generating the second appearance of the visual characteristic of the respective portion of the respective watch face includes generating the second appearance using the respective application installed on the electronic device, the one or more programs further include instructions for:
after receiving the watch face package, in accordance with a determination that the one or more criteria are not satisfied because the requirement that the respective application be installed on the electronic device is not satisfied, displaying, at the electronic device, the pre-generated appearance of the visual characteristic of the respective portion of the respective watch face using the first display data associated with the respective portion of the watch face, and without using the respective application.

17. The electronic device of claim 16, wherein the one or more programs further include instructions for:
in accordance with a determination that the requirement that the respective application be installed on the electronic device is not satisfied:
receiving a user input corresponding to the respective application; and
in response to the user input:
in accordance with a determination that the user input corresponds to a request to download the respective application, initiating a process to download the respective application; and
in accordance with a determination that the user input does not correspond to the request to download the respective application, initiating a process to install the watch face package on the electronic device without the respective visual element.

18. The electronic device of claim 17, wherein a second respective portion of the watch face corresponds to a second respective visual element of the one or more visual elements configured to display information from a second respective application, the one or more programs further include instructions for:
in accordance with a determination that a requirement that the second respective application be installed on the electronic device is not satisfied:
receiving a second user input corresponding to the second respective application; and
in response to the second user input:
in accordance with a determination that the user input corresponds to a request to download the second respective application, initiating a process to download the second respective application; and
in accordance with a determination that the user input does not correspond to the request to download the second respective application, initiating the process to install the watch face package on the electronic device without the second respective visual element.

19. The electronic device of claim 13, wherein the one or more programs further include instructions for:
after receiving the watch face package:
initiating a process to install the watch face package on the electronic device, wherein after installing the watch face package on the electronic device, the respective watch face is available to be used at a respective electronic device.

20. A non-transitory computer readable storage medium storing one or more programs configured for execution by one or more processors of an electronic device, the one or more programs comprising instructions for:
receiving a watch face package, the watch face package including one or more definitions of visual characteristics of one or more portions of a respective watch face, wherein a respective definition corresponding to a respective portion of the watch face includes:
first display data associated with the respective portion of the watch face, wherein the first display data defines a pre-generated appearance of a visual characteristic of the respective portion of the watch face; and
second display data associated with the respective portion of the watch face, wherein the second display data defines a second appearance of the visual characteristic of the respective portion of the watch face; and
after receiving the watch face package:
in accordance with a determination that one or more criteria are satisfied, generating, at the electronic device, the second appearance of the visual characteristic of the respective portion of the respective watch face using the second display data associated with the respective portion of the watch face.

21. The non-transitory computer readable storage medium of claim 20, wherein the one or more programs further include instructions for:
after receiving the watch face package, in accordance with a determination that the one or more criteria are not satisfied, displaying, at the electronic device, the pre-generated appearance of the visual characteristic of the respective portion of the respective watch face using the first display data associated with the respective portion of the watch face, without generating the pre-generated appearance.

22. The non-transitory computer readable storage medium of claim 20, wherein the one or more portions of the respective watch face include one or more visual elements configured to display information from one or more respective applications.

23. The non-transitory computer readable storage medium of claim 22, wherein:
the respective portion of the watch face corresponds to a respective visual element of the one or more visual elements configured to display information from a respective application;
the one or more criteria include a requirement that the respective application is installed on the electronic device;
generating the second appearance of the visual characteristic of the respective portion of the respective watch face includes generating the second appearance using the respective application installed on the electronic device, the one or more programs further include instructions for:
after receiving the watch face package, in accordance with a determination that the one or more criteria are not satisfied because the requirement that the respective application be installed on the electronic device is not satisfied, displaying, at the electronic device, the pre-generated appearance of the visual characteristic of the respective portion of the respective watch face using the first display data associated with the respective portion of the watch face, and without using the respective application.

24. The non-transitory computer readable storage medium of claim 23, wherein the one or more programs further include instructions for:
in accordance with a determination that the requirement that the respective application be installed on the electronic device is not satisfied:
receiving a user input corresponding to the respective application; and
in response to the user input:
in accordance with a determination that the user input corresponds to a request to download the respective application, initiating a process to download the respective application; and
in accordance with a determination that the user input does not correspond to the request to download the respective application, initiating a process to install the watch face package on the electronic device without the respective visual element.

25. The non-transitory computer readable storage medium of claim 24, wherein a second respective portion of the watch face corresponds to a second respective visual element of the one or more visual elements configured to display information from a second respective application, the one or more programs further include instructions for:
in accordance with a determination that a requirement that the second respective application be installed on the electronic device is not satisfied:
receiving a second user input corresponding to the second respective application; and
in response to the second user input:
in accordance with a determination that the user input corresponds to a request to download the second respective application, initiating a process to download the second respective application; and
in accordance with a determination that the user input does not correspond to the request to download the second respective application, initiating the process to install the watch face package on the electronic device without the second respective visual element.
